(19) United States
(12) Patent Application Publication
(10) Pub. No.: US 2003/0221783 A1
(43) Pub. Date: Dec. 4, 2003

(54) IR WELDING OF FLUOROPOLYMERS

(75) Inventor: Glenn A. Evans, Highland Heights, OH (US)

Correspondence Address: CALFEE HALTER & GRISWOLD, LLP, 800 SUPERIOR AVENUE, SUITE 1400, CLEVELAND, OH, 44114, US

(73) Assignee: Swagelok Company, Solon, OH (US)

(21) Appl. No.: 10/250,275

(22) Filed: Jun. 19, 2003

Related U.S. Application Data
(63) Continuation of application No. 09/830,786, filed on May 1, 2001, now Pat. No. 6,437,994.
Application No. 09/830,786 is a continuation-in-part of application No. 09/567,603, filed on May 10, 2000, now abandoned.

(51) Int. Cl. B32B 31/24

(52) U.S. Cl. 156/359; 156/380.9

(57) ABSTRACT

Apparatus for welding plastic workpieces together includes a heater block having first and second surfaces; a first heating element for radiating heat from the first surface; and a second heating element for radiating heat from the second surface; wherein the first and second heating elements being separately controlled for temperature. Temperature sensors are provided for detecting temperature of the workpieces at the weld sites. The heating elements preferably are laid out in a non-planar manner such as a parabolic, convex or other curved or angled configuration so as to focus, direct or otherwise concentrate the radiated heat toward the weld site on the workpiece. The invention is particularly suited for welding a part made of a melt processable material such as PFA to a part made of a non-melt processable material such as modified PTFE.

### CROSS REFERENCE TO RELATED APPLICATIONS

This application is a continuation of co-pending U.S. Non-Provisional patent application Ser. No. 09/580,786, which s a continuation-in-part of and claims the benefit of co-pending U.S. Non-Provisional patent application Ser. No. 09/567,603 filed on May 10, 2000 for IR WELDING OF FLUOROPOLYMERS, the entire disclosure sof which iarefully incorporated herein by reference.

### BACKGROUND OF INVENTION

### TECHNICAL FIELD OF THE INVENTION

The subject invention relates generally to welding or joining nonmetallic fluoropolymer parts together. More particularly, the invention relates to method and apparatus for radiant welding two workpieces together wherein the workpieces may be heated to different temperatures during a welding operation.

A known technique for welding or joining plastic parts or workpieces together is radiant heating, sometimes called infrared or IR welding. In a known process, the workpieces are heated and then pressed together and allowed to cool. A heater is used to provide a radiant heat source that is held close to those portions of the workpieces that are to be joined together.

Numerous deficiencies are present in known IR welding systems. Among them are the poor repeatability, inconsistency of the welds and long weld cycle times. This can be attributed to a number of factors, many of which are related to the fact that the welding operator must visually determine when each work piece has been sufficiently heated. With Teflonâ□ [symbol] ]type materials such as PFA, for example, the operator looks for a change in the opacity of the workpiece. This is a very subjective determination and results in inconsistent welds.

Known systems are only useful for welding two workpieces of the same material, and only materials such as PFA that are melt processable. Melt processable refers to materials that can be melted and further processed such as by injection molding or other processing technique in which the molten material flows. Materials that are not melt processable are not believed to have been IR welded heretofore using known IR systems. Another significant limitation of known systems is that there is very little control over how much of the workpiece is heated. For a typical welding operation, usually only a small part of the workpiece requires heating. Known systems however heat portions of the workpiece other than the actual weld site. Such heat can adversely or undesirably affect the material characteristics of the workpiece outside the weld site. Still further, known welding systems typically use fixtures to hold the workpieces during the welding and cool down time periods. These fixtures typically axially constrain movement of the workpieces during cool down, thus producing residual stresses in the weld.

The need continues to exist for a radiant welding method and apparatus for welding plastic parts together to produce high quality repeatable welds. Such method and apparatus will be particularly but not exclusively suited for welding two workpieces of different material together that have different melting and decomposition temperatures.

### SUMMARY OF INVENTION

The present invention contemplates in one embodiment an apparatus for welding plastic workpieces together wherein the apparatus includes a heater block having first and second heat radiating surfaces; a first heating element for radiating heat from said first surface; and a second heating element for radiating heat from said second surface; wherein the first and second heating elements are separately controlled for temperature.

Another aspect of the heater block is that the heating elements and/or the radiant surfaces may be profiled with a geometry that focuses or directs or concentrates the radiated heat to a weld area or zone. In one embodiment, the heating elements are laid out in a parabolic, convex or other non-planar manner.

In accordance with another aspect of the invention, the welding system separately or in combination includes temperature sensors for the heating elements and also temperature sensors for detecting temperature of the workpieces at the weld sites.

In accordance with another aspect of the invention, the workpieces to be welded are mounted on fixtures that facilitate the formation of acceptable welds. In accordance with this aspect of the invention, at least one of the workpieces is permitted to displace axially and freely relative to the other workpiece during a post-weld period of time. This free movement allows the weld site to cool without producing residual stresses at the weld site. In one embodiment of the invention, a fixture is used that holds a workpiece during a part of the welding operation and axially releases the workpiece during a welding and cool down period.

These and other aspects and advantages of the present invention will be readily appreciated and understood from the following detailed description of the invention in view of the accompanying drawings.

### BRIEF DESCRIPTION OF DRAWINGS

FIG. 1 is a functional block diagram of a welding system in accordance with the invention;

FIGS. 2A-2D respectively are side elevation, front elevation, top and isometric views of a heater block assembly in accordance with the invention;

FIGS. 3A-3G are simplified schematic representations of a typical welding operation in accordance with the invention;

FIGS. 4A and 4B are an simplified illustrations of the heating effect of the heater block, for different sized parts, in accordance with the invention;

FIGS. 5A and 5B are a software flow chart for an exemplary welding process that may be implemented using the present invention;

FIGS. 6 and 7 are temperature vs. time graphs of exemplary workpiece heating profiles in accordance with the invention;

FIGS. 8A-8C illustrate a first embodiment of a fixture concept in accordance with the present invention; and

FIGS. 9A-9D illustrate a second embodiment of a fixture concept in accordance with the invention.

### DETAILED DESCRIPTION

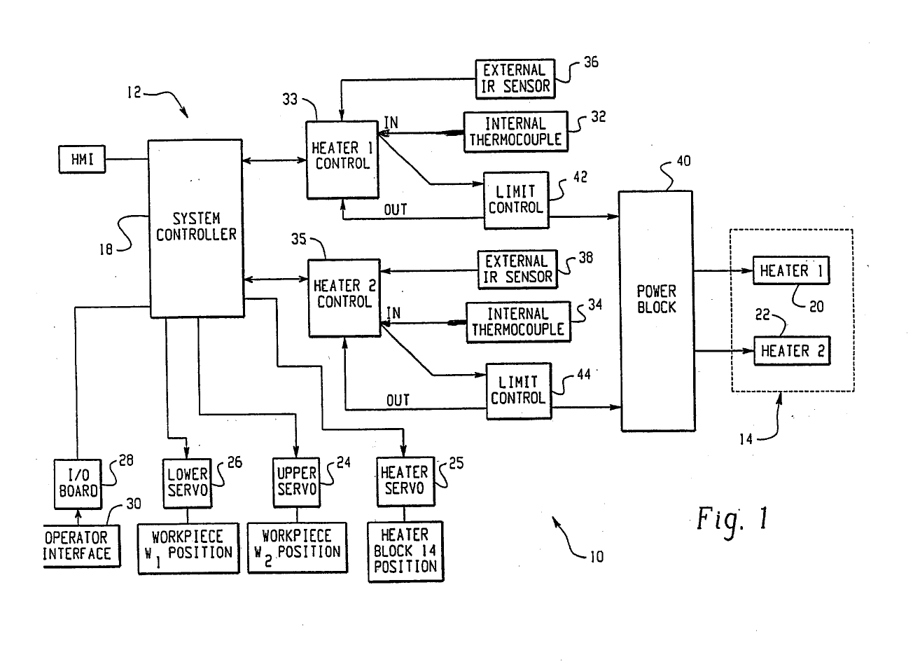

A welding system 10 for radiant non-contact heating and welding of fluoropolymer parts together is illustrated in the exemplary function block diagram of FIG. 1. Although the invention is described herein with specific reference to-welding a PFA part to a modified PTFE part (i.e. a melt processable material to a non-melt processable material), these are but two examples of fluoropolymers that may be welded using apparatus and methods that embody one or more of the various aspects of the present invention. The present invention may also be used to weld two parts of the same material together (e.g. a part made of a melt processable material, such as PFA, to a melt processable part, or a part made of a non-melt processable material, such as a modified PTFE, to a non-melt processable part).

The present invention contemplates a number of significant aspects embodied in the methods and apparatus of the welding system 10, each of which may be used either alone or in any combination with the other aspects of the invention. In general, these aspects are embodied in but are not limited to a novel heater unit and a control system for controlling a welding operation based on one or more of the following: temperature of the heating elements, workpiece temperature at the weld site, and position control of the workpieces. The novel heater unit embodies two distinct aspects or features which in general are: 1) separate and independent temperature control of at least two heating elements; and 2) focused or directed radiant heating. A further aspect of the control system is the use of a selectable heating profile for each workpiece. Although the invention is described herein by way of exemplary embodiments for welding two workpieces of different materials, those of ordinary skill in the art will readily understand that various aspects of the invention may be used for welding workpieces together of the same material.

Additionally, while a number of alternative embodiments or examples are presented herein, such examples are not intended to be and should not be construed as being an exhaustive list. Many different electrical, mechanical and materials variations to the described embodiments will be readily apparent to those skilled in the art, whether explicitly stated herein or not, and such variations may be made without departing from the spirit and scope of the invention.

With reference to FIG. 1 then, a radiant welding system that embodies various aspects of the present invention is illustrated. Reference herein to “welding” should be understood in its broadest sense, i.e. joining or uniting two workpieces by the application of heat. The invention is directed to radiant or IR heating techniques by convection of heat from a radiant surface to the workpiece without direct contact of the workpiece with the heat radiant surface. This assures a clean weld.

The system 10 includes a control circuit 12, a heater block assembly 14 and a fixture platform or frame 16 (not shown). The control circuit 12 may be realized in many forms including discrete circuits, integrated circuits, analog and/or digital circuits and so on as is well known to those skilled in the art. In the exemplary embodiment of FIG. 1, the control circuit 12 includes a digital controller 18, which may be any suitable microprocessor or other digital controller device or circuit. The controller 18 executes a number of control functions during a welding operation. These functions include: 1) controlling relative position of the workpieces W₁ and W₂ with respect to each other; 2) controlling position of the heater block assembly 14 relative to the workpieces; 3) controlling power to the heating elements 20, 22 in the heater block assembly 14; 4) receiving and processing various feedback signals related to position of the workpieces and heaters as well as temperature feedback signals; and 5) executing a welding operation in accordance with one or more stored programs, control parameters, heating profiles and operator inputs.

Position control of the workpieces W₁ and W₂ and the heater block 14 may be carried out with conventional servo controls, however, any other suitable position control technique may be used. The workpieces W₁ and W₂ may be moved and positioned by the control circuit 12 via first and second workpiece position servos 24, 26. Suitable servo controls such as part B8001 available from IDS may be used for example. A third position control 25 is used to move and position the heater block assembly 14. For example, the heater block 14 may be mounted on a moveable arm under control of an air cylinder 25 so that the heater block 14 may be moved between a retracted or home position and an extended or welding position near the workpieces W₁ and W₂. Alternatively, the heater block 14 could be fixed in position. Allowing for position control of the heater block 14 allows the heater to be safely retracted away from personnel when not in use. Also, by having a moveable heater block 14, a plurality of heater blocks 14 may be used for different part sizes or welding parameters. Still further, having a moveable heater block 14 under electronic control substantially increases the flexibility of the welding system 10 to carry out repeatable high quality welds as will be further described hereinbelow.

The control circuit 12 further may include a standard Input/Output circuit 28 available from Grayhill that interfaces the controller 18 with various external sensors, the heater block 14 power circuit, as well as an operator interface device 30 such as a keyboard, touch screen, mouse and so on. A suitable interface device is Model 400 available from Eason. The operator may input, for example, materials of the parts being welded, part sizes, temperature parameters and so on, as well as select an appropriate welding procedure stored in memory, or have the controller 18 select the appropriate procedure. The welding parameters may be entered and monitored via a conventional video display or other suitable way, with menu driven programs and so forth. Data storage devices may be used to store weld parameters and welder data for historical purposes, quality control, trend analysis and other statistical analyses as required.

It should be noted that although the invention is described herein as embodied in a computerized or automated welding system 10, many aspects of the invention may be realized in simpler systems including manual systems. For example, the heater block 14 may be easily used with a manual welding system in which the workpieces are manually oriented with respect to the heater 14 using any suitable fixturing apparatus. The various temperature feedbacks may also be operator monitored and adjusted if so desired. However, it is contemplated that an automated system will be preferred in most cases since a complete welding operation may be carried out independent of operator interaction once the parameters have been set. This greatly increases weld quality, repeatability and reduces welding times.

Associated with each of the heating elements 20, 22 is a temperature sensor 32, 34. The temperature sensors 32, 34 in this case are standard thermocouples and are preferably but not necessarily positioned near the heating elements within the heater block assembly 14. Any suitable temperature sensor may be used. Each sensor 32, 34 is monitored so that the separate temperatures of the heating elements 20, 22 are controlled independent of each other. The independent and accurate temperature control of each heating element 20, 22, as well precise temperature controls and selectable heating profiles, is one of the significant features of the invention that permits workpieces of different materials to be welded together.

Additional temperature sensors 36, 38 are provided for detecting workpiece temperature at the weld site. In this embodiment, precision infrared sensors, such as model no. RAYTXSLTCF2 available from RAYTEK detect the weld site temperature of each of the workpieces W₁ and W₂. By using this workpiece temperature feedback, the controller 18 can determine precisely when the workpieces have been heated to a predetermined temperature for welding. This eliminates a major drawback of prior systems in which the operator must visually determine, by a change in opacity of the part, that a part was sufficiently heated. Using the workpiece temperature sensors 36, 38 also permits the controller 18 to adjust power to the heating elements 20, 22 to prevent overheating when, for example, one of the workpieces reaches its weld temperature before the other workpiece fully heats. The controller 18 may also be programmed to adjust distance of the workpiece from the heater as part of the workpiece temperature control function. This may be done in combination with or in lieu of heater power adjustments.

A standard power interface circuit 40 provides voltage and current to the heating elements 20, 22. A suitable circuit is a Din-a-Mite circuit available from Watlow. Conventional power limit circuits 42, 44 may also be used as required. Such as a series 146 control circuit available from Watlow.

In the exemplary embodiment of FIG. 1, the control circuit 12 further includes heater controllers 33, 35. Each heater controller 33, 35 independently adjusts voltage and current applied to its respective heater to reach the programmed heater temperature set by the system controller 18. Each heater controller 33, 35 may be for example a 988 controller available from Watlow. Each heater controller monitors the respective heater thermocouple 32, 34 and adjusts power to the power circuit 40 to maintains the heaters at the selected temperature. The heater controllers 33, 35 also monitor the respective IR sensor signal. When the associated weld site reaches the desired weld temperature, the heater controller sends an appropriate signal to the system controller 18. When both workpieces reach weld temperature, the system controller 18 moves the heater block away from the workpieces and brings the workpieces together to make the weld.

Independent temperature controls of the two heaters, as well as separate temperature monitoring of the weld sites of the workpieces, facilitates welding two workpieces of dissimilar materials. For example, one of the workpieces may reach its weld temperature faster than the other. Should this occur, the associated heater control function can adjust power to the heater to maintain the workpiece at weld temperature without overheating, until such time that the second workpiece reaches its weld temperature. The weld temperature of each workpiece may be the same or different from each other and can be reached at different times since the parts may heat at different rates.

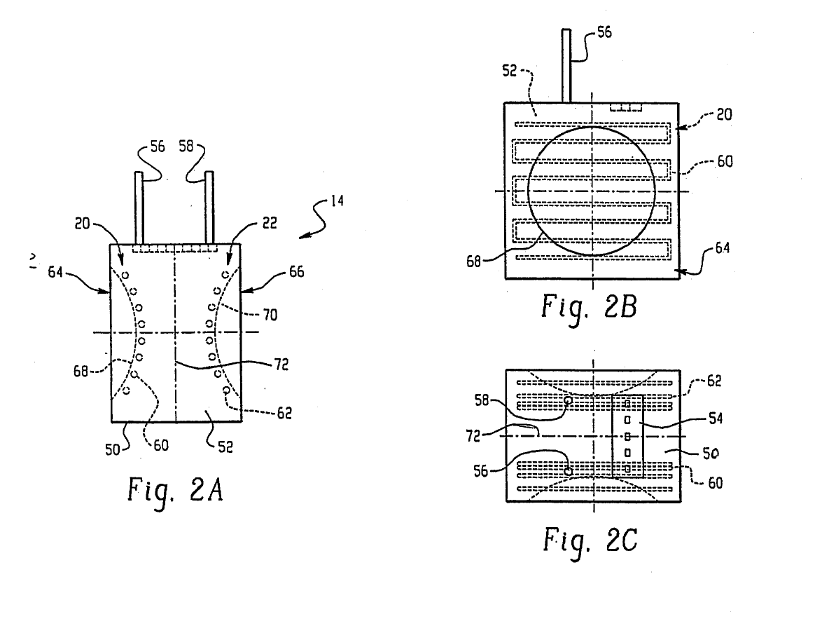

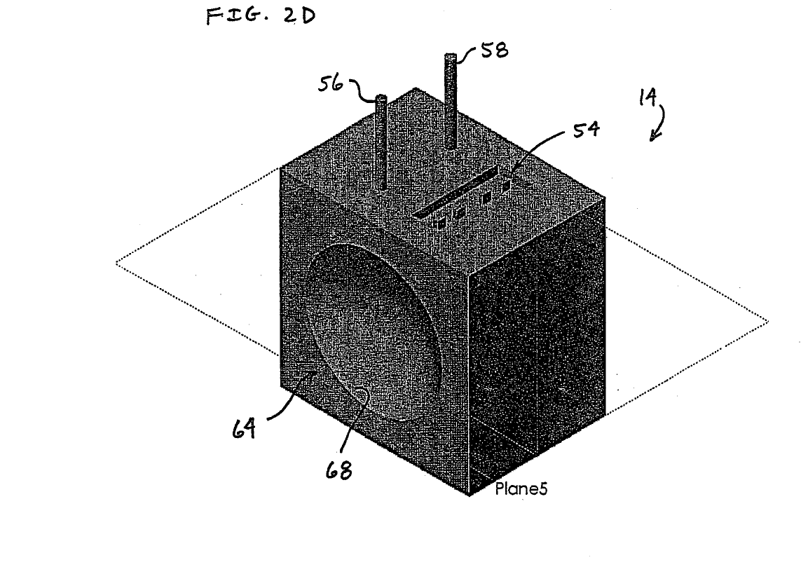

With reference to FIGS. 2A, 2B and 2C, the invention contemplates a heater block assembly 14 that in this example includes a single housing or casing 50. Within the housing 50 is a thermal or heat radiant matrix 52. In this exemplary embodiment, the matrix 52 is made of a ceramic material such as, for example, ceramic fiber insulation available from WATLOW. This particular material is a moldable ceramic, however, any suitable material may be used for the heater matrix 52 provided it supports the heating elements if so required and radiates sufficient heat for the welding processes.

The casing 50 includes a terminal block for connecting electrical power leads to the heating elements 20, 22 embedded in the matrix 52. The heater temperature sensors 32, 34 (FIG. 1) are disposed within the matrix 52 in close proximity to the respective heating elements 20, 22. Connector leads 56, 58 may be used to connect the sensors 34, 36 to the system controller 18 via the I/O board 28.

In this embodiment, each heating element 20, 22 is realized in the form of a conventional resistive heating wire 60, 62 such as iron chrome aluminum wire. Each wire 60, 62 is laid out in a serpentine manner (FIG. 2B), and along a curved or other non-planar profile or configuration (FIG. 2A). The non-planar profile in this exemplary case is generally parabolic or concave so that there is a focusing or directional effect to the radiated heat. One aspect of the invention encompasses the concept of having a directed or concentrated radiated heat source. The radiated heat may be “focused” as described herein by the use of a parabolic or concave heating element profile, however, focusing to a specific focal point is not required. The general aspect of the invention therefore is that the radiated heat be generally directed or concentrated in the region of the weld site.

The non-planar profile may be any geometry that produces a directional concentration or focusing effect to the radiated heat. However, it is possible that in some welding systems, a focused or concentrated heat is not required. In such cases, the wires 60, 62 may be laid out in a planar fashion. The wires 60, 62 also need not be serpentine in arrangement. Other non-planar profiles may be used depending on how much of a focusing effect is required. For example, the wires 60, 62 may be laid out on an angled plane such as a V-shaped configuration. Many other options may be available, including adding or using a heat-focusing element in or with the heater block 14.

As illustrated in FIGS. 2A and 2B, the ceramic matrix 52 is formed with two heat radiating surfaces 64, 66. These surfaces 64, 66 may also be geometrically configured to assist in the radiated heat focusing effect. The exemplary embodiment, each surface 64, 66 includes a generally parabolic or concave portion 68, 70 which may generally conform to the geometry of the wires 60, 62 or alternatively may be formed with a different geometric profile. Any profile may be used to achieve the desired focusing effect.

A number of advantages are realized by the use of the directed heat concept of the invention. Among these advantages is the more efficient heating of each workpiece. Prior systems generated broadly radiated heat some of which inefficiently did not even affect the workpiece, must less heat the workpiece at the weld site (as used herein, weld site refers to that portion of a workpiece that is to be heated to its melting temperature so as to carry out a welding operation). By concentrating the radiated heat at or near the weld site, the workpiece can be heated faster and more efficiently. Another advantage of directing or concentrating the radiated heat is that it reduces heating of portions of the workpiece away from the weld site. For example, suppose a valve body made of a modified PTFE polymer and includes a tube end to which a fitting is to be welded. Ideally, only the outer end of the tube end (about ⅛ inch for example) would be heated. If the valve body is heated at the same time and the temperature increases sufficiently, the modified PTFE material may be adversely affected. By concentrating or directing the radiated heat, peripheral heating of non-weld portions of a workpiece may be substantially reduced.

In FIGS. 2A-2C the heater block assembly 14 is an integrated unit with a single casing 50; The two heating elements 20, 22 may be separated into their own zones by a wall or other thermal barrier or reflector 72 if required. Alternatively, the heating elements 20, 22 may be disposed in separate matrix/casing units that are secured together or mounted together to a common translation device. Another alternative would be to have each heating element 20, 22 within its own heater block assembly so that the control circuit 12 could independently position each heater near its associated workpiece. FIG. 2D is a solid model isometric illustration of a heater block 14 that incorporates a concave portion of the heat radiating surface 64.

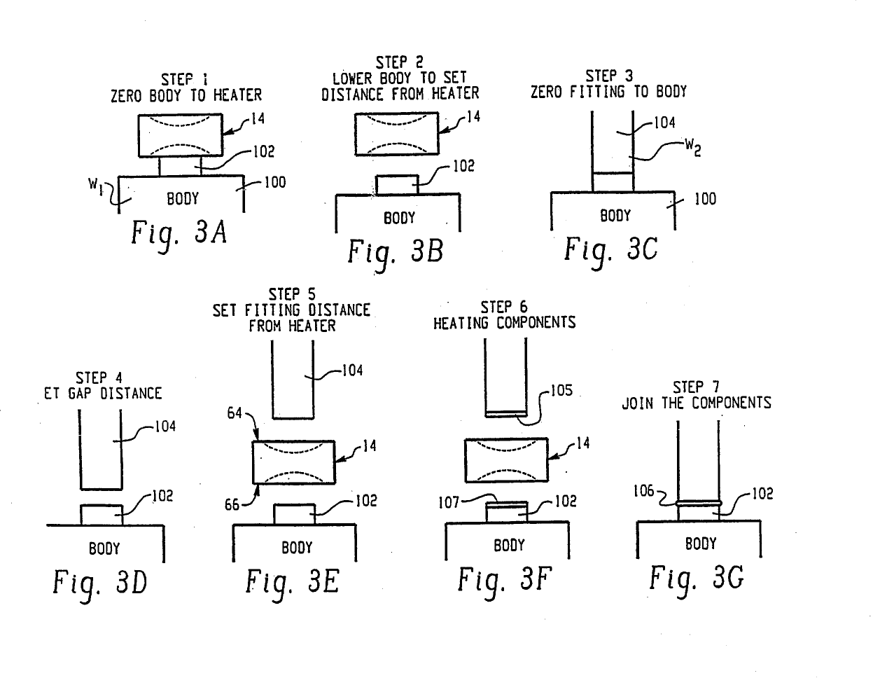

With reference to FIGS. 3A-3G a typical welding operation that may be executed by the control circuit 12 or manually or otherwise is illustrated in a simplified manner. In these views, the fixturing and other electrical and mechanical features of the system 10 are omitted for clarity. Additionally, the example of FIGS. 3A-3G assumes a moveable heater block 14 and independently moveable workpieces W₁ and W₂.

In this example, the first workpiece W₁ is a valve body 100 having a tube end 102 to which a fitting 104 is to be welded. The first workpiece W₁ may be held with a conventional fixture such as clamps on a first moveable platform or other suitable structure positioned by the control circuit 12 via the first workpiece position servo 26. The second workpiece W₂in this example is a tube end 104 of a fitting or other part that is to be welded to the first workpiece W₁. The second workpiece W₃ may also be mounted on a moveable platform or other suitable structure that is positioned by the control circuit 12 via operation of the second workpiece position servo 24. As illustrated in the figures, preferably but not necessarily required, the invention contemplates a vertical alignment of the workpieces for welding. This achieves a more uniform weld bead. Alternatively, the workpieces may be welded with a horizontal alignment or any other required orientation. Simpler welding systems also may only utilize one moveable workpiece.

The heater block 14 is also mounted on a moveable platform or arm under control of the control circuit 12 via the heater servo 24. In the exemplary embodiment, the heater block 14 is translated transverse the axis of movement of the workpieces W₁ and W₃ (i.e. horizontally or transverse the plane of the paper of FIGS. 3A-3G). The heater block 14 may be moved at differing angles if so desired relative to the translation axis of the workpieces W₁ W₂, but for convenience can be moved in a plane that lies generally transverse or otherwise non-parallel to the translation axis of the moveable workpieces W₁ and W₂. With reference to FIG. 3A, a welding procedure is initiated by the control circuit 12 moving the workpiece W₁ to the location that the heater block 14 will be moved, determine a zero position reference point for the workpiece W₁ In FIG. 3A the heater 14 is illustrated in position, but in practice the heater position may be indicated by a capacitive position sensor. The zero reference point can be set moving the workpiece W₁ up until the capacitive sensor (not shown) indicates the workpiece is at the heater position. A capacitive sensor, proximity sensor or other suitable position sensor may be used to determine when the zero position has been located.

With reference to FIG. 3B, the first workpiece W₁ is then retracted a predetermined distance or gap away from the zero position. This distance may be empirically determined based on the amount of heat radiated from the heater 14 and the desired temperature that the workpiece is to reach during a welding operation, as well as the growth the part will undergo upon exposure to the heat during a welding operation.

With reference to FIG. 3C, the second workpiece W₂ is moved into position and touched off against the first workpiece W₂ in order to find a zero position of the second workpiece relative to the first workpiece. A load cell or other suitable contact sensor may be used to determine when the zero position has been located.

In FIG. 3D, the second workpiece is moved away from the first workpiece 102 a predetermined gap distance based on the amount of growth that is expected for each workpiece due to heating during the welding operation and the amount of overlap required for the two parts to be pressed together after the heating phase is completed. The gap distance thus may be in general empirically determined. The gap distance also functions as a programmable stop. Thus, after the parts are heated, the second workpiece is moved to its zero reference or stop position, but since the parts have “grown” or enlarged during heating, they will overlap and the softer melt processable workpiece tube end 104 will be upset to form a weld bead based on the amount of overlap provided. Thus, the welding process is position based rather than force based as the parts are moved into contact to complete the weld.

In FIG. 3E, the workpieces have further been separated by the predetermined distance away from the respective heater faces 64, 66. The actual distance between the first workpiece W₁ and the associated heater face 66 may be the same or different than the distance between the second workpiece 104 and the second heater face 64 of the heater block assembly 14. Again, these distances will depend on the material of each workpiece and the optimized or empirically determined distance from the associated heater face in order to effect the most efficient heating of the workpiece for a given welding operation.

In FIG. 3F, electrical power has been applied to the heater block 14 such that the workpiece ends 105, 107 are heated to a temperature sufficient to allow the workpieces to be joined or otherwise welded together.

In FIG. 3G, the workpieces have been moved into engagement with each other to complete the welding operation thereby forming a weld bead 106.

A significant advantage of the present invention is that the independent two heater design allows for two workpieces made of different materials to be efficiently and effectively welded together using a radiant welding process. For example, tube fittings such as the second workpiece 104 may be made of a PFA Teflonâ [symbol] type material that is a melt processable material and exhibits a melting temperature within a first range of temperatures. The valve body for example may be made of a different Teflonâ [symbol] type material such as a modified PTFE, which is not a melt processable material and exhibits a much higher melting point temperature. By having independent temperature controls for both heating elements 20, 22 and temperature sensors for the weld site, such workpieces can be conveniently welded together using the radiant heat welding technology. It is important to note that the materials described herein for the workpieces, namely PFA and a modified PTFE, are intended to be exemplary in nature only and should not be construed as a limitation to the scope of the present invention. The present invention may conveniently be used for welding parts of the same material together as well as parts that are made of different materials that exhibit significantly different melting point characteristics, or in which one of the parts is made of a non-melt processable material while the other part is made of a melt processable material. It is preferred but not required that the workpieces be heated to a temperature that is at or somewhat greater than the melting point temperature for that material but less than the decomposition temperature of that material.

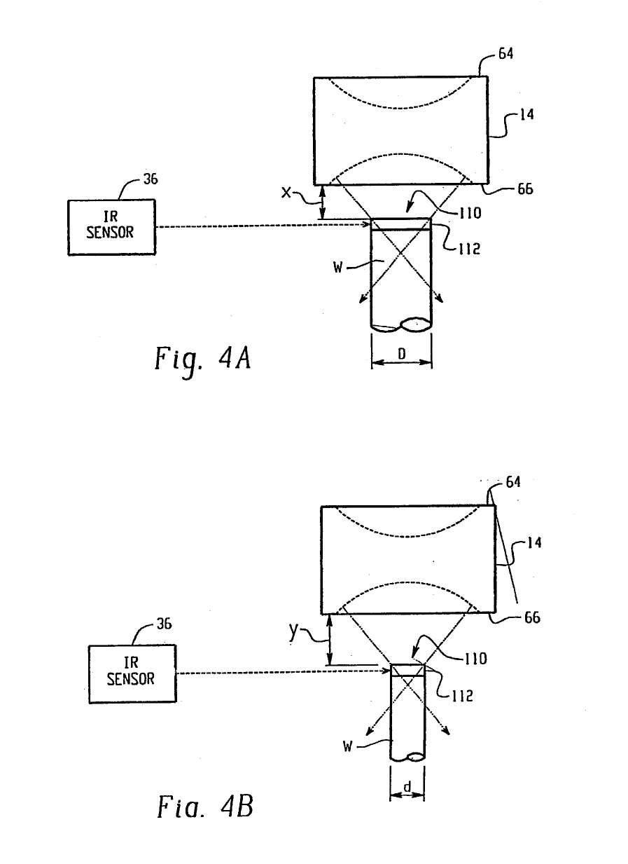

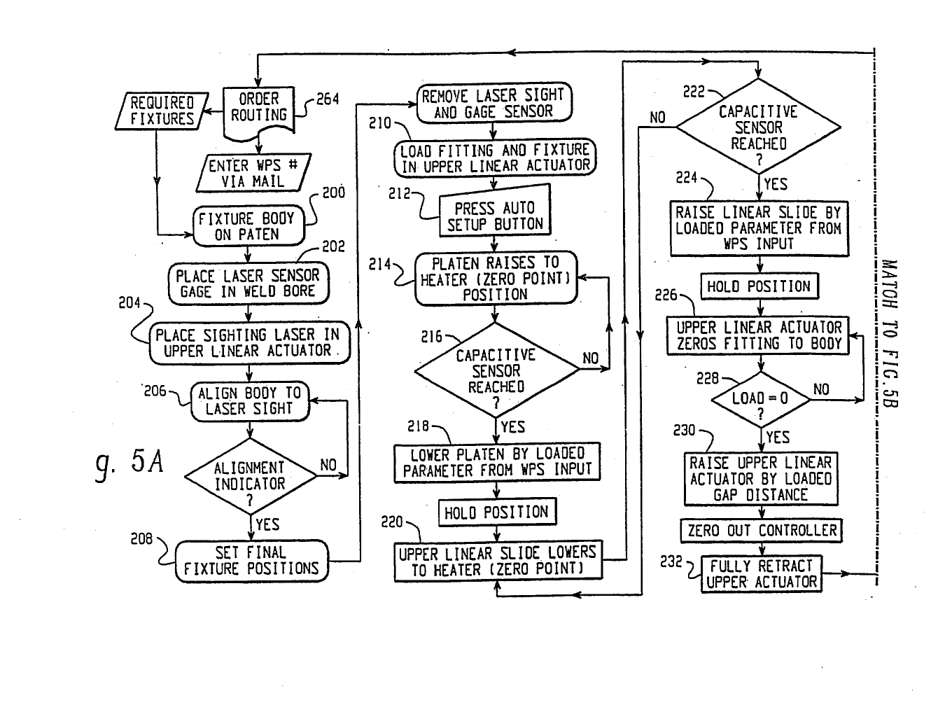

With reference to FIGS. 4A and 4B, there is illustrated an enlarged view of the relationship between the heater block 14 and a workpiece W such as a PFA tube end. As illustrated in FIG. 4A, the non-planar profile of the heating elements 20, 22, in this case the generally parabolic or convex profile, tends to focus or direct the radiated heat toward a localized heat area or zone 110. In this example, the heat is radiated in a somewhat conical fashion. This local heating area can be empirically determined as to its position, and the weld site end of the workpiece W moved into position for heating during a welding operation such that the portion of the workpiece to be welded. 112.(i.e. the weld site) is within the radiated heat. The heated portion of the workpiece however does not necessarily have to be positioned right at the localized zone 110 but can be positioned at other locations along the heat zone 110 relative to the heat radiating surface of the heater block 14 to carry out the desired heating rate and temperature increase of the workpiece during a welding operation. In FIG. 4B a different sized workpiece is illustrated to exemplify how the smaller part will tend to be positioned further from the heater block 14 compared to the larger workpiece of FIG. 4A (distance “Y” being greater than distance “X”). However, the actual heating distances X and Y will depend on the materials of the parts, part geometry, desired heating rate, desired temperature and so forth. The present invention thus contemplates a complete thermal management system for an IR welding procedure that controls the temperature at the weld site by controlling the temperature of the heating elements, the workpiece temperature and the workpiece position.

As also shown in FIG. 4A, the workpiece temperature sensor, in this case in the form of an infrared heat sensor 36, is used to detect the actual temperature of the workpiece at the weld site 112 during a welding operation. The sensor 36 may detect surface temperature at the weld site, but preferably is aimed so as to detect the temperature at a location below the surface that will indicate that the weld temperature has been reached and sufficiently penetrated the part. The temperature sensor 36 produces an electrical signal that is fed back to the system controller 18 whereby the controller 18 can precisely control the temperature of the workpiece during welding either by adjusting power to the associated heating element 20, 22 and/or by alternatively adjusting the position of the workpiece W relative to the heat radiated surface 66. In this manner, the automated welding system 10 can accurately and precisely determine when the workpiece W has been sufficiently heated to be welded to the other workpiece. This eliminates any need for the operator to make a subjective visual determination the workpiece has been sufficiently heated.

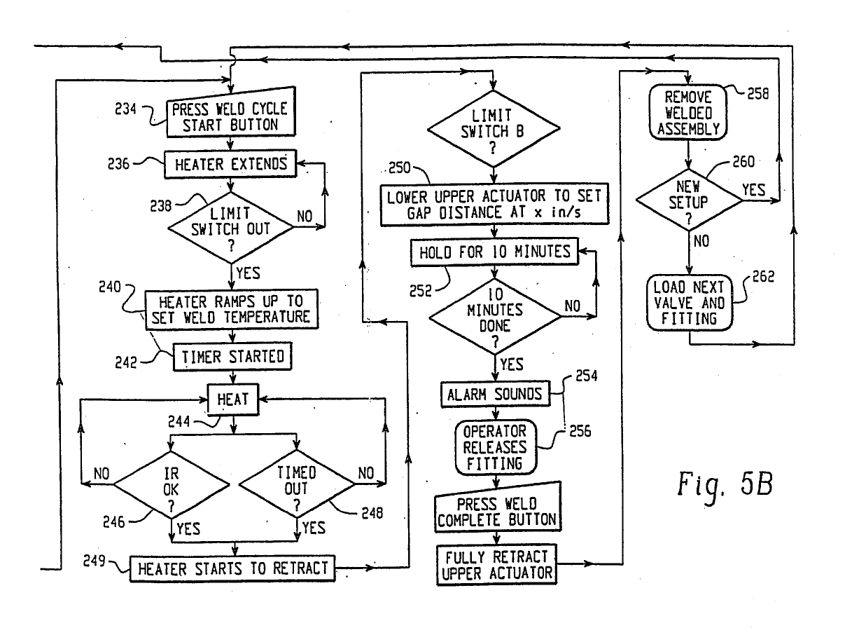

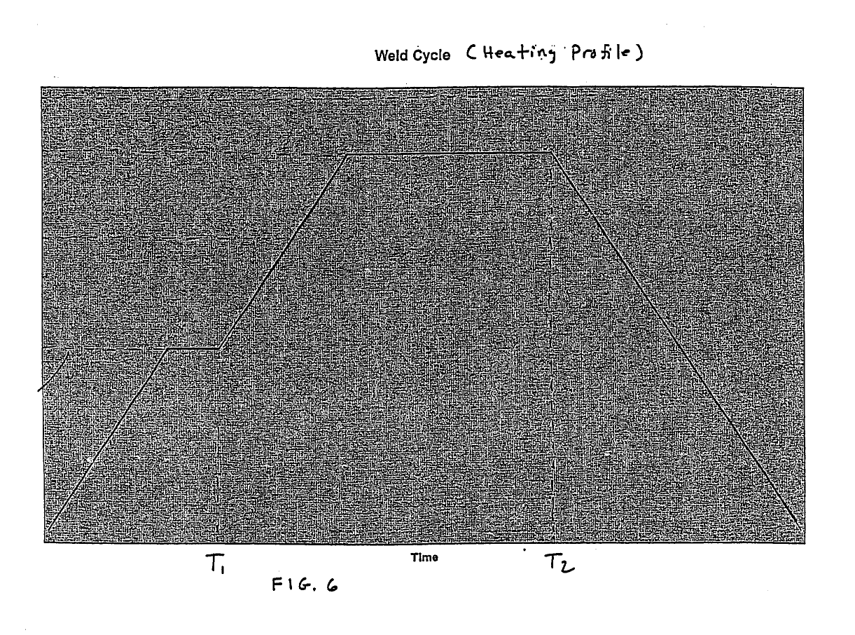

With reference to FIGS. 5A and 5B, an exemplary software flow diagram is provided for a typical welding operation that can be executed by the control system 12. At step 200 the operator mounts the first workpiece on a movable platform or platen and at step 202 through 208, the workpiece may be aligned such as through a laser sighting technique as is known in the art. At step 210 the second work is mounted to its actuator and at step 212 the operator initiates an automated set-up routine.

At step 214 the movable platform holding the first workpiece is raised until the workpiece contacts the heater block 14. This sets a zero point reference for the first workpiece. Contact of the workpiece with the heater block 14 may be accomplished, for example, by capacitive sensors and/or load cells or any other suitable position detection technique as at step 216. At step 218 the workpiece is lowered away from the heater 14 to a predetermined starting point based on various input parameters from the operator including part size, materials and so forth. This initial gap is based on the expected growth of the part due to heating. At step 220 the second workpiece W₂ is lowered until it contacts the heater block 14 to establish a zero reference point for the second workpiece, again as detected by an appropriate contact sensor such as a capacitive sensor at step 222.

At step 224, the second workpiece is raised to a predetermined starting point, again as determined by the size of the part and the material of the part based on expected growth during heating. At step 226, the second workpiece is moved toward the first workpiece until it contacts that workpiece as detected by load cell step 228. This establishes zero position for contact between the two workpieces. At step 230, the second workpiece is raised to a predetermined gap distance, again based on the part dimensions and material properties. At step 232, the second workpiece is fully retracted and at step 234 the operator initiates the selected welding procedure.

At step 236, the heater block 14 is extended from its home position to its welding position as detected by a limit switch at step 238. At step 240, power is applied to the heater to initiate temperature increase of the heater block. Alternatively, the heater may have been preheated during the time that the heater was in the home-retracted position. In such a case, at step 240, the heater power is then increased to raise the heater temperature to the desired welding temperature, which is selected and controlled for each workpiece independently. At step 242, a welding timer is initiated. By accurately controlling the temperature of the heating elements 20, 22 as well as the workpiece temperature at the weld site, the workpieces can be heated starting at step 244 until the workpiece temperature sensor at step 246 determines that the workpiece has been heated to its proper temperature. The timer used at step 248 to assure that the workpiece is heated within a predetermined time window otherwise a possible fault with the heater block or related circuitry may be indicated. After the workpiece temperature sensor determines that the workpiece has been properly heated to the welding temperature at step 246, at step 249 the heater block is retracted once again to its home or retracted position.

At step 250, the workpiece actuators move the workpieces into contact to join the two parts together. At step 252, the parts are held together for approximately ten (10) minutes in this example. An audible and/or visual alarm may be provided at step 254 to alert the operator that the welding procedure has been completed and at step 256, the operator can remove the completed structure from the fixture apparatus at step 258. At step 260, the operator determines whether similar parts will be welded during the next cycle or whether a new set-up is required due to a part change. At step 262, the next pair of workpieces are loaded into the apparatus, and the welding procedure is reinitiated back to step 234. If a new set-up is required at step 264 program loops back to step 200 and the various parameters for the welding operation may be input by the operator.

With reference to FIG. 6, a typical heating profile for the heating elements 20, 22 in accordance with the invention is illustrated. In prior known systems, the heaters would be activated and simply heat up to some predetermined but not regulated temperature. Therefore, workpiece heating at the weld site was not controlled and inconsistent. In accordance with the invention, because of the use of the heating element temperature sensors and the workpiece temperature sensors, the workpieces can be heated with any desired heating profile. In the example of FIG. 6, the heating elements 20, 22 are initially heated to a first temperature T1 that is preferably but not necessarily below the melt temperature T3 of the workpiece material. The workpiece may be soaked at this temperature for a period of time prior to the actual welding operation. We have found that in some applications this presoak may result in better and more consistent welds. After the optional soak period T1, the heating elements 20, 21 are heated so that the workpiece temperature at the weld site is raised to a temperature T2 that is above the melt temperature T3 but below the decomposition temperature T4. The workpieces may then be joined by pressing the parts together as previously described herein. Following the welding period T2, the welded parts may be subjected to a cooling profile as required.

With reference to FIG. 7, another heating profile is illustrated. In this graph, line A is the measured temperature of one of the heaters 20, 22 and line B is the measured temperature of the other heater. In this embodiment, the heaters are gradually ramped up in temperature to a selected temperature T1 and then that temperature is maintained while the workpieces heat up. The graphs illustrate how the control circuit 12 operates in a conventional manner to control the heater temperatures. For example, the control circuit 12 may implement a conventional PID control algorithm.

In the example of FIG. 7, both heaters 20, 22 are ramped to the same temperature, but this is not required and will depend on the sizes and materials of the associated workpieces. FIG. 7, also graphically illustrates how the temperature of each heater is independently controlled relative to the other heater.

Lines C and D in FIG. 7 chart the workpiece W, and W₂ temperatures at the weld site. The workpiece temperatures gradually increase until they reach the selected welding temperature, which in the example of FIG. 7 occurs at about time T1. At that time, the heaters are removed and the workpieces are joined as previously described herein. In FIG. 7 the line C falls off due to measurement technique. Line C corresponds to the moveable workpiece, so that when it is moved into contact with the other workpiece, the weld site is displaced from the “view” of the IR temperature sensor. In actual practice, line C would show a gradual cool down in a manner analogous to line D. The jump in line D that occurs at T1 is the temperature increase that occurs at the weld site when the two workpieces are joined.

The examples of FIGS. 6 and 7 are intended to be exemplary in nature. The selected heating profile may be determined for each particular part or material being welded.

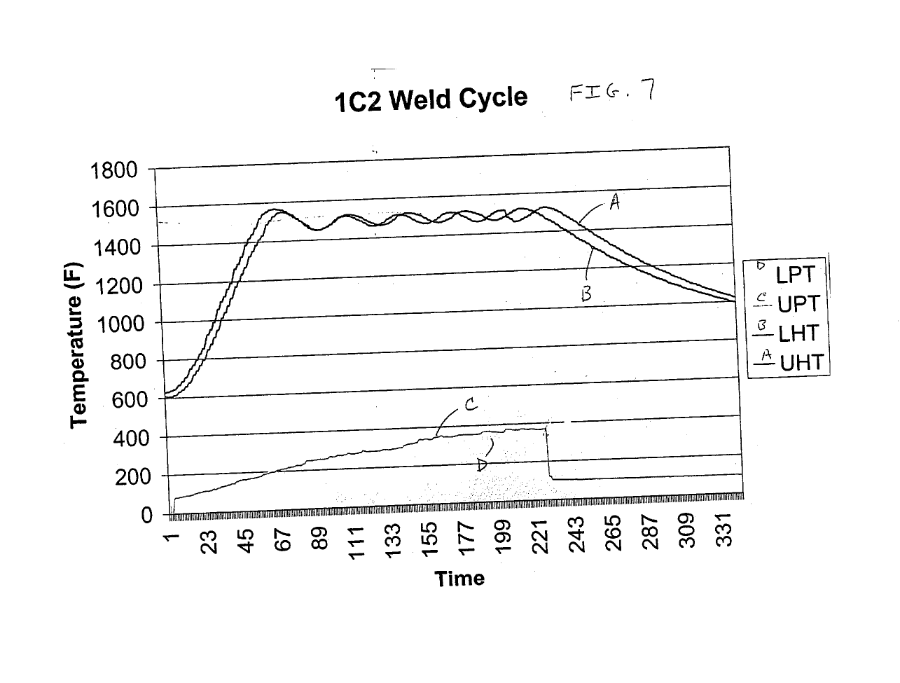

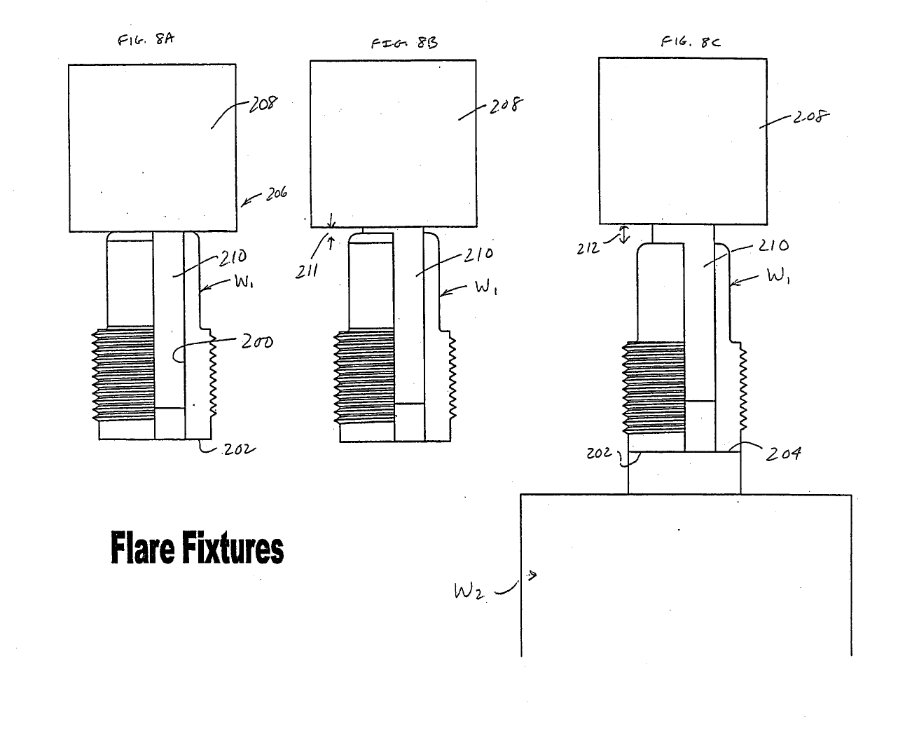

With reference to FIGS. 8A-8C, the invention also contemplates fixturing concepts that improve final weld quality and strength by substantially reducing applied forces and residual stresses at the weld. In accordance with this aspect of the invention, at least one of the workpieces is mounted on a fixture such that as the weld cools, the workpiece is axially free to move relative to the fixture. This allows the weld to cool without axial constraint or residual stress.

In the exemplary embodiment of FIGS. 8A-8C, a first workpiece W₁, in this example a threaded fitting tube end, is to be welded to a second workpiece W₂ such as a valve. The drawings are simplified for clarity and show only the workpieces and one of the fixtures. In this example the valve W₂ is the moveable workpiece.

The concept embodied in FIGS. 8A-8C relates to a tubular workpiece having a central bore 200 therethrough. The lower end 202 (as viewed in the drawings) of the workpiece W₁ is the end that will be welded to a corresponding tube end 204 on the other workpiece. These ends 202, 204 define the weld site. The fixture 202 in this case is the moveable fixture that allows the workpieces to be joined (as described herein before with reference to FIGS. 3A-3G).

In this example, the central bore 200 is not a true cylinder but rather has a slight axial taper because the part is a molded part. The fixture concept however may also be applied to workpieces that are not tapered or molded. The fixture 206 includes a base 208 that is installed on a suitable support (not shown). The base 208 is moveable by a suitable actuator as described hereinbefore. Extending from the base 208 is a fixture mount or pin 210. The pin 210 is appropriately sized so as to have a slight interference or frictional fit with the workpiece bore 200 before the workpiece is heated as part of a welding operation.

In FIG. 8A the workpiece W₁ is mounted on the fixture 210 prior to heating and is snugly held on the pin 210. In FIG. 8B the workpiece has been heated as part of a welding operation. During the heating time period, the workpiece “grows” so as to have a substantially reduced grip on the pin 210, but with enough residual gripping force such that the workpiece does not fall off the pin 210. The reduced frictional interference between the workpiece and the fixture 206 decreases to the point that the fitting is able to slide along the pin 210 during cooling of the formed weld. After the workpieces have reached their respective welding temperature, the parts are joined and the fixture and pin 210 are held in position. In FIG. 8C, during cool down (for example from about 400 degrees C. to about 270 degrees C.) the fixture 206 is held in position as the weld cools. Since the frictional fit has been substantially removed, the shrinkage that occurs due to the weld cooling pulls on the workpiece which is now free to axially slide along the pin 210. Those skilled in the art will appreciate that the movement described is rather small but significant. If the workpiece were not free to slide along the pin 210, residual stresses would form in the weld. The workpiece is removed from the pin 210 before complete cool down, otherwise the workpiece would return to its original dimensions and be snugly retained on the pin 210. This complete cool down may be used however when required. The slight axial displacement of the workpiece along the pin 210 is exaggerated as the gap 212 in FIG. 8C for clarity. The workpiece W₁ is still radially aligned during cool down, but is axially unconstrained so that the weld can cool with little or no residual stress.

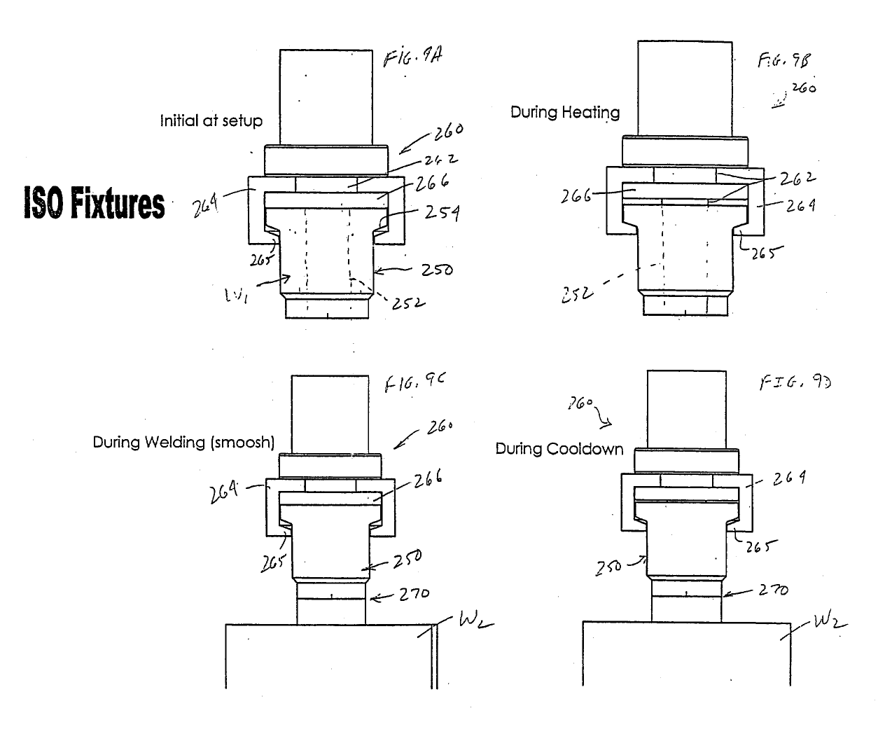

With reference to FIGS. 9A-9D, an alternative embodiment of the fixturing concept is illustrated. This embodiment is useful for parts such as a standard ISO tube end fitting 250 that has a substantially cylindrical inner bore 252. The ISO fitting is the moveable workpiece W₁ and in this example is being welded to a valve body W₂.

A standard ISO fitting is characterized by a radially outward extending flange 254. The fixture 260 is configured to loosely capture the fitting 250 and hold it in radial alignment via a pin 262 that extends into the central bore 252 of the fitting. The fixture 260 includes a collar 264 that radially captures the fitting 250 and has an inward extending flange 265 that axially catches the fitting flange 254. FIG. 9A shows initial setup with the fitting 250 installed in the fixture 260. A slight interference fit with the pin 262 may be used if required. The fitting 250 is axially unconstrained but supported within the fixture 260. In FIG. 9B the workpieces have been heated and in FIG. 9C, the workpieces have been joined. When the fitting 250 is heated, it no longer has an interference fit with the pin 262. As shown in FIG. 9C, when the weld joint 270 is made, the workpiece 250 has been pushed up against a stop 266 in the fixture 260. As the weld 270 cools, the fitting 250 is axially free to back away and is axially unconstrained while at the same time still being radially aligned. Thus, in accordance with this aspect of the invention, the fixtures allow the welds to cool with at least one of the joined workpieces being axially unconstrained.

The exemplary embodiments of FIGS. 8A-8C and 9A-9D have specific structural features that are used due to the specific fitting design or geometry being welded. These embodiments should not be construed in a limiting sense. The salient feature is that at least one of the workpieces is supported during the heating step, but is axially unconstrained during the post-weld cool down step to eliminate residual stresses.

The invention has been described with reference to the preferred embodiment. Modifications and alterations will occur to others upon a reading and understanding of this specification. It is intended to include all such modifications and alterations insofar as they come within the scope of the appended claims or the equivalents thereof. IN

1. An apparatus for welding fluoropolymer workpieces together, comprising:
a heater block having a first and second surface;
a first heating element for radiating heat from said first surface;
a second heating element for radiating heat from said second surface;
said first and second heating elements being separately controlled for temperature; and
a fixture comprising a base; a member extending from said base and adapted to engage one of said workpieces; said member radially aligning said workpiece and axially holding said workpiece prior to heat being applied to said workpiece;
wherein the workpiece is axially unconstrained on said member after the workpiece has been heated as part of a welding operation.

2. The apparatus of claim 1 wherein said first and second heating elements are disposed in a single housing.

3. The apparatus of claim 1 wherein at least one of said surfaces is non-planar.

4. The apparatus of claim 1 wherein both of said surfaces are non-planar.

5. The apparatus of claim 1 wherein at least one of said heating elements is laid out in a non-planar configuration.

6. The apparatus of claim 5 wherein said non-planar heating element is laid out along a curved path.

7. The apparatus of claim 5 wherein said non-planar heating element concentrates heat radiated from one of said surfaces.

8. The apparatus of claim 1 wherein said first and second heating elements direct heat radiated from said first and second surfaces.

9. The apparatus of claim 1 comprising a control circuit that controls respective temperatures of said first and second heating elements independent of each other.

10. The apparatus of claim 1 wherein said first temperature control circuit comprises first and second temperature sensors each respectively sensing temperature of an associated one of said heating elements.

11. The apparatus of claim 1 wherein said second temperature control circuit comprises a weld temperature sensor for detecting temperature of a workpiece being heated by one of said heating elements.

12. The apparatus of claim 11 comprising a second weld temperature sensor for detecting temperature of a second workpiece being heating by the other of said heating elements.

13. The apparatus of claim 12 wherein said weld temperature sensor comprises an IR heat sensor.

14. The apparatus of claim 1 comprising first and second fixtures for holding first and second workpieces to be welded together, at least one of said fixtures being mounted on a moveable platform, and a control circuit for controlling position of said workpieces relative to each other for a welding operation.

15. The apparatus of claim 14 wherein said heater block is moveable between a retracted position and a welding position near said workpieces.

16. The apparatus of claim 15 comprising first and second heating element temperature sensors that provide signals to said control circuit corresponding to temperatures of said heating elements.

17. The apparatus of claim 16 comprising first and second weld site temperature sensors that provide signals to said control circuit corresponding to temperatures of said workpieces.

18. The apparatus of claim 9 wherein said control circuit controls heating of said heating elements according to a predetermined temperature profile.

19. The apparatus of claim 18 wherein said temperature profile includes a stepwise ramp sequence during a heating time period.

20. A heater for welding plastic workpieces, comprising:
a heater block;
first and second heating elements disposed in said heater block wherein each heating element is separately controlled as to temperature relative to the other heating element; and
a fixture element, wherein said fixture element comprises a base and a member extending from said base; wherein at least one of said workpieces is engaged by said member such that said at least one workpiece is radially aligned and axially held by said member prior to heat being applied, and wherein said at least one workpiece is axially unconstrained by said member after heat is applied.

21. The heater of claim 20 wherein at least one of said heating elements is laid out in a non-planar configuration.

22. The heater of claim 20 wherein said heater block comprises first and second non-planar surfaces that radiate heat from said first and second heating elements.

23. The heating of claim 20 wherein heat radiated from said heater block is focused.

24. An apparatus for welding parts together, comprising:
first and second heating elements that can be positioned to heat first and second workpieces;
sensors for detecting temperature of said heating elements;
sensors for detecting temperature of the workpieces at the weld site;
a control circuit that receives said sensor outputs and controls heating of the workpieces in accordance with a heating profile based on said temperature sensor outputs; and
a fixture element, wherein said fixture element comprises a base and a member extending from said base; wherein at least one of said workpieces is engaged by said member such that said at least one workpiece is radially aligned and axially held by said member prior to heat being applied, and wherein said at least one workpiece is axially unconstrained by said member after heat is applied.

25. The apparatus of claim 24 wherein said workpieces are made of the same material.

26. The apparatus of claim 24 wherein one workpiece is made of a melt processable material and the other workpiece is made of a non-melt processable material.

27. The apparatus of claim 24 wherein one workpiece is made of PFA material and the other workpiece is made of modified PTFE material.

28. The apparatus of claim 24 wherein said heating elements concentrate radiated heat within a predetermined region to heat the workpieces primarily at a weld site.

29. The apparatus of claim 24 wherein said control circuit controls relative position of the workpieces with respect to each other and said heating elements.

30. An apparatus for welding fluoropolymer workpieces together, comprising:
a heater having first and second heating elements associated therewith, and
a fixture element comprising a base and member extending from said base; wherein at least one of said workpieces is engaged by said member such that said at least one workpiece is radially aligned and axially held by said member prior to heat being applied, and wherein said at least one workpiece is axially unconstrained by said member after heat is applied.

31. The apparatus of claim 30 wherein each of said heating elements concentrates radiated heat towards a respective workpiece.

32. The apparatus of claim 30 wherein said heating elements are disposed in a matrix that is shaped to concentrate the radiated heat.

33. The apparatus of claim 30 wherein said heating elements are laid out in a generally parabolic configuration.

34. The apparatus of claim 30 wherein said heating elements are laid out in a generally non-planar configuration.

35. A fixture for a workpiece being welded by infrared heat, the fixture comprising:
a base;
a member extending from said base and adapted to engage said workpiece; said member radially aligning said workpiece and axially holding said workpiece prior to heat being applied to said workpiece;
the workpiece being axially unconstrained on said member after the workpiece has been heated as part of a welding operation.

36. The fixture of claim 35 wherein said member comprises a pin that has an interference fit with the workpiece prior to the workpiece being heated.

37. The fixture of claim 35 wherein said member comprises a collar that captures a corresponding flange on the workpiece.

38. The apparatus of claim 1, wherein said fixture member comprises a pin that has an interference fit with the workpiece prior to the workpiece being heated.

39. The apparatus of claim 1, wherein said fixture member comprises a collar that captures a corresponding flange on the workpiece.
